(19) United States
(12) Patent Application Publication
(10) Pub. No.: US 2005/0249921 A1
(43) Pub. Date: Nov. 10, 2005

(54) Forming artistic works from medusae

(76) Inventor: William W. Ward, Metuchen, NJ (US)

Correspondence Address: Mr. Walter J. Tencza Jr., Suite 3, 10 Station Place, Metuchen, NJ, 08840, US

(21) Appl. No.: 10/838,676

(22) Filed: May 4, 2004

(51) Int. Cl. B32B 1/00

(52) U.S. Cl. 428/195.1; 427/4

(57) ABSTRACT

A method is disclosed comprising the steps of placing a sheet on top of a first towel, placing a medusa or jellyfish on top of the sheet to form a combination sheet and medusa, and allowing the medusa to dry. The first towel may be on top of a first stack of a plurality of towels. The method may further include taking the combination sheet and medusa off of the first towel, and placing it into a first bath. The combination sheet and medusa may be taken out of the first bath and placed into a second bath. The method may further include taking taking the combination sheet and medusa out of the second bath, placing it on top of a second towel, and allowing the medusa to dry. The method may also include applying color to the medusa.

### FIELD OF THE INVENTION

This invention relates to improved methods and apparatus concerning forming artistic works.

### BACKGROUND OF THE INVENTION

There are various techniques which are known for forming artistic works.

### SUMMARY OF THE INVENTION

The present invention in one or more embodiments provides a process in which fragile, diaphanous marine organisms (such as jellyfish, ctenophores, nudibranchs, sea hairs, sea nettles, medusae, siphonophores, and related cnidarians and coclenterates, which will be referred to collectively medusae in this application and any one of which may be referred to as a medusa), are air dried onto sheets of paper, such as fiberglass paper, preserved with a solution of ten percent formalin, and then differentially colored with a variety of organic biological stains and/or inorganic salt solutions.

The present invention in one or more embodiments provides a method comprising the steps of placing a sheet on top of a first towel, placing a medusa on top of the sheet to form a combination sheet and medusa, and allowing the medusa to dry. A plurality of medusae may be placed on top of the sheet. The first towel may be on top of a first stack of a plurality of towels. The sheet may be made of fiber glass.

The method may further include taking the combination sheet and medusa off of the first towel, and placing the combination sheet and medusa into a first bath. The first bath may be comprised of a solution containing ten percent formalin.

The combination sheet and medusa may be taken out of the first bath and placed into a second bath. The second bath may be comprised of gently flowing water. The method may further include taking the combination sheet and medusa out of the second bath, placing the combination sheet and medusa on top of a second towel, and allowing the medusa to dry.

The method may also include applying color to the medusa. Color may be applied to the medusa by soaking the combination sheet and medusa in a third bath. The third bath may be comprised of a biological stain dissolved in a solvent. The medusa may be allowed to dry after the combination sheet and medusa has soaked in the third bath.

The present invention, in one or more embodiments, also provides an apparatus compising a sheet and a medusa.

### BRIEF DESCRIPTION OF THE DRAWINGS

FIG. 1 shows a flow chart of a method in accordance with an embodiment of the present invention; and

FIG. 2A shows a side view of a simplified diagram of two medusae placed on a sheet to form a combination sheet and medusae which is placed on top of a first stack of towels;

FIG. 2B shows a cross sectional view of a simplified diagram of the combination sheet and medusae of FIG. 2A placed in a first bath containing a first solution;

FIG. 2C shows a cross sectional view of a simplified diagram of the combination sheet and medusae of FIG. 2A placed in a second bath containing a second solution;

FIG. 2D shows a side view of a simplified diagram of the combination sheet and medusae which is placed on top of a second stack of towels; and

FIG. 2E shows a cross sectional view of a simplified diagram of the combination sheet and medusae of FIG. 2A placed in a third bath containing a third solution.

### DETAILED DESCRIPTION OF THE DRAWINGS

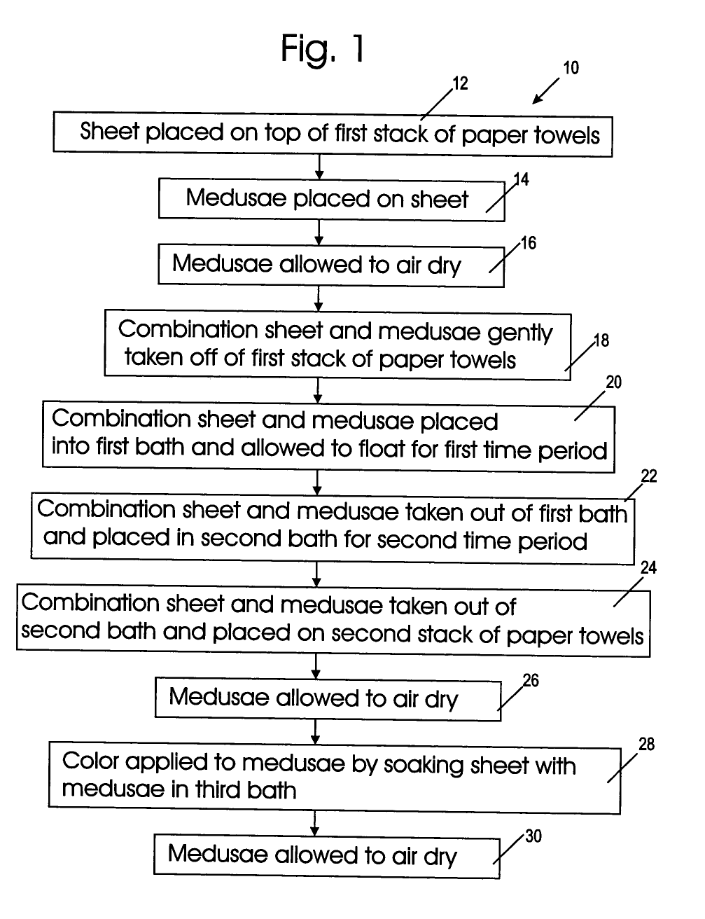

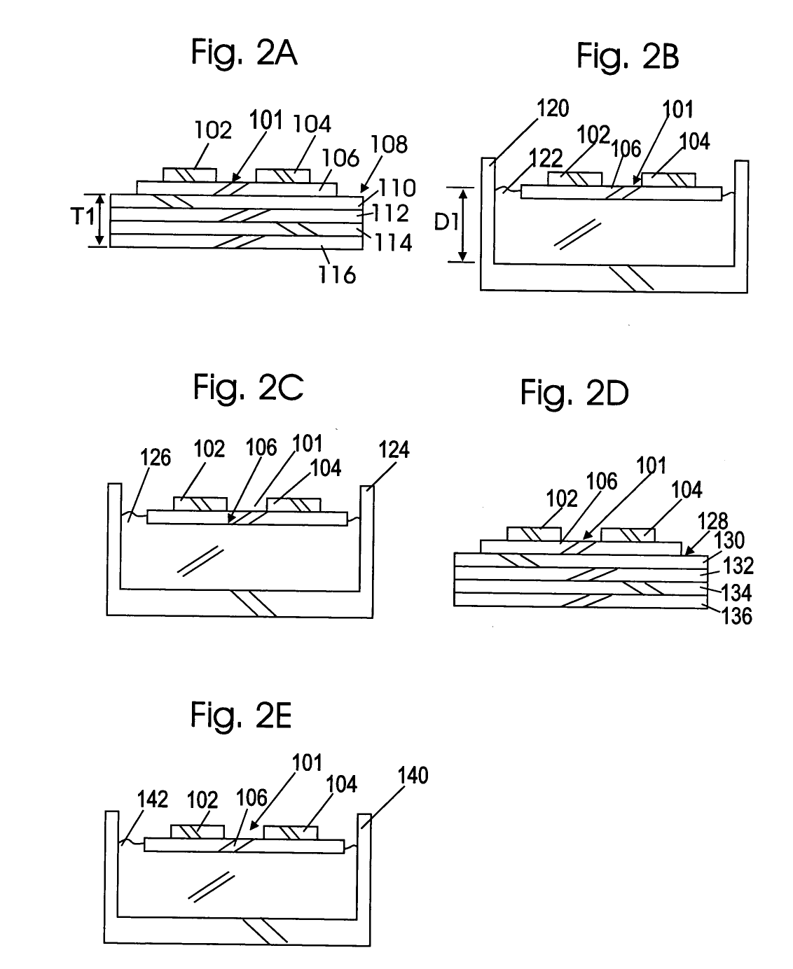

FIG. 1 shows a flow chart 10 of a method in accordance with an embodiment of the present invention. FIGS. 2A-E are simplied diagrams of various components at various steps of the method shown by the flow chart 10.

At step 12 of FIG. 1, a sheet 106 is placed on top of a first stack 108 of paper towels as shown in FIG. 2A. The sheet 106 may be an eight inch by ten inch loosely woven, textured sheet of Whatman EMP—2000 (trademarked) glass fiber filter paper (made by Whatman, Inc.(trademarked), 9 Bridewell Place, Clifton, N.J. 07014) or an eight inch by eleven and one half inch loosely-woven, textured sheet of Whatman QMA (trademarked) quartz fiber filter paper or an equivalent high quality, loosely-woven textured paper. At step 14 one or more medusae, which have been freshly collected from the ocean so that they are dripping wet with ocean water, such as medusa 102 and 104 shown in FIG. 2A, are carefully placed on the sheet 106. At step 16 the medusae 102 and 104 are allowed to air dry while they are sitting in the position shown in FIG. 2A. The medusae 102 and 104, along with sheet 106 form a combination sheet and medusae 101.

The first stack 108 may have a thickness T1, shown in FIG. 2A, which may be about two inches and the first stack 108 and may be comprised of a plurality of highly absorbent paper towels, such as paper towels 110, 112, 114, and 116 in FIG. 2A. The medusa 102 and 104, sheet 106 and the first stack 108 in FIG. 2A should be placed in a warm, dry location having moderate air flow. For example, an indoor, sunlit flat surface (e.g. in an artist's loft) may be an ideal location.

In the configuration of FIG. 2A, the first stack 108 of paper towels beneath the sheet 106 absorbs and/or draws away virtually all of the water, salts, and water-soluble small molecules that make up the liquid portion of the so-called hydroskeleton of the medusae 102 and 104. Remaining, in dried form, in their relative anatomical locations, are most of the macromolecules of the body of the medusae 102 and 104, including proteins, muscular tissues, nucleic acids, proteoglycans, glycoproteins, collagen fibers, and other connective tissue elements of the medusae 102 and 104. As the water and salts are removed by absorption into the first stack 108 of paper towels, the delicate macromolecular structures of the bodies of the medusae 102 and 104 are drawn into the sheet 106, for example, in the case of a textured fiber glass sheet 106, forming a relatively tight bond with coarsely woven fibers of the textured fiber glass. After this occurs, the layer of biological material due to the medusae 102 and 104 is so thin as to appear one with the sheet 106—as if painstakingly painted onto the surface of an artist's canvas. This careful drying process preserves the gross morphology of the medusae 102 and 104 in much the same way as pressing a tree leaf between the pages of a book preserves the gross morphology (and even the taxonomic identity) of that leaf. However, unlike the tree leaf, the medusae 102 and 104 are now bonded to the sheet 106 as if painted there. Larger medusae, containing a large volume of water, may require a thicker layer of absorbent paper towels for stack 108 or may need to be transferred to an additional stack of towels (prior to next stage shown in FIG. 2B) The initial stage of drying (70-90% removal of water) typically needs to occur in the first two to four hours (from the time that the medusae 102 and 104 are placed on the sheet 106 above the first stack 108 of paper towels) so as to prevent microbial degradation and subsequent liquifaction of the medusae 102 and 104. The complete drying process, prior to the step shown by FIG. 2B, requires twelve to thirty-six hours, depending on the aqueous volume of the medusae 102 and 104 and the external relative humidity. Complete drying (90% of water removal) temporarily preserves the medusae and provides for their firm attachment to the sheet 106.

After air drying of the medusae 102 and 104 in the stage shown by FIG. 2A, the combination sheet and medusae 101 is gently removed from the first stack 108 of paper towels at step 18. The combination sheet and medusae 101 is then placed into a first bath, i.e. into a solution 122 located in a receptacle 120, as shown in FIG. 2B. The combination sheet and medusae 101 is allowed to float in the solution 122 for a first time period at step 20. The first time period may be thirty minutes. The solution 122 may be a shallow solution, i.e. the depth D1 of the solution 122 in receptacle 120 may be only one centimeter, as shown in FIG. 2B. The combination sheet and medusae is typically about one millimeter thick. The solution 122 may be ten percent formalin (a 1/10 dilution of 37% weight to volume solution formaldehyde typically prepared by alkaline depolymerization of paraformaldehyde and subsequently adjusted to near pH neutrality by the addition of six molar hydrochloric acid with final buffering to pH 8.0 or pH 7.0 accomplished by the addition of ten mM (millimolar). Tris base (Tris-hydroxymethylamino methane) or 10 mM sodium phosphate, respectively. Formalin treatment “fixes” and permanently preserves the “impression” given by medusae 102 and 104 on sheet 106, by chemically cross-linking proteins and other macromolecules to each other and by, in effect, “gluing” biological macromolecules and biological tissues to the fibers of the typically fiberglass sheet 106.

At step 22 the combination sheet and medusae 101 is taken out of the first bath and placed in a second bath, i.e. into a solution 126 located in a receptacle 124 as shown in FIG. 2C, for a second time period. The formalin is removed by transferring the fiberglass sheet 106 (containing the chemically fixed “impression”) into the second bath of FIG. 2C by applying a solution or liquid typically of gently flowing water, for an additional thirty minutes.

The combination sheet and medusae 101 is taken out of the second bath and placed on a second stack 128 of paper towels at step 24, as shown in FIG. 2D. The second stack 128 of paper towels includes towels 130, 132, 134, and 136. The combination sheet and medusae 101 is allowed to air dry, while in the position of FIG. 2D, at step 26. The combination sheet and medusae 101 is typically allowed to air dry for twenty-four hours. After this stage, the combination sheet and medusae 101 can be stored in any reasonably dry location for at least fifteen years with no noticeable deterioration of gross anatomical features and no noticeable odor.

Color may be applied to the medusae 102 and 104, at step 28 by soaking the combination sheet and medusae 101 in a third bath, i.e. in solution 142 located in receptacle 140, as shown in FIG. 2E. The combination sheet and medusae 101 is then taken out of the receptacle 140, and allowed to air dry, at step 30 on a sheet of aluminum foil or the combination sheet and medusae 101 may be placed on absorbent paper towels to effect more rapid drying.

Color can be applied, as shown by FIG. 2E, by soaking the combination sheet and medusae 101 in solution 142 for ten to thirty minutes. The solution 142 may be a bath of biological stain dissolved in absolute methyl alcohol or a variety of other solvents. Suitable biological organic stains include, but are not limited to, neutral red, methyl green, Coomassie brilliant blue R, Janus green, Sudan red, fluoresecin, rhodamine B, congo red, and Lucifer yellow. Alternatively, or in combination with organic stains, chelated and non-chelated inorganic metal salts such as salts of copper, cobalt, potassium, and cadmium may be employed as stains. Color variation, color contrast, multi-color effects, and aesthetic appeal are achieved by varying: (a) the type of dye, (b) the length of exposure to the dye solution, (c) the application of a second or third staining solution to the same “impression”, (d) addition of small volumes of water, glacial acetic acid, or concentrated ammonium hydroxide to the stain solution, (e) differential de-staining in a bath of clear methyl alcohol (or alternate solvent), and (f) differential drying (by rapid absorption on a stack of paper towels or by slow, evaporative drying on a sheet of aluminum foil.) While rapid absorption may be used to remove excessive background stain (from areas peripheral to the medusa 102 and medusa 104“impression”) evaporative drying produces an unusually attractive mottled background, as the residual stain appears to “puddle” into patches as it dries.

The combination sheet and medusae 101, after being subjected to the process of FIG. 1, can be mounted in suitable picture frames and sold as original signed pieces of art. The combination sheet and medusae 101, after being subjected to the process of FIG. 1, may be overlain with or impregnated with polymeric materials, such as those commonly used to preserve fragile canvas paintings. Digital color images of the combination sheet and medusae 101, after the process of FIG. 1, may be stored on computer disk following scanning by a high resolution multicolor, computer-interfaced scanner. Such digitally stored images may be used to reproduce “prints” of varying sizes, also to be sold as pieces of fine art. Other commercial applications of such “marine impressions” include, but are not limited to, fabric design, porcelain china design, tee shirt design, and the design of note cards, greeting cards, stationary, coasters, bookmarks, paperweights, calendars, book covers, and various novelties.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. A method comprising the steps of
placing a sheet on top of a first towel;
placing a medusa on top of the sheet to form a combination sheet and medusa; and
allowing the medusa to dry.

2. The method of claim 1 further comprising
taking the combination sheet and medusa off of the first towel; and
placing the combination sheet and medusa into a first bath.

3. The method of claim 2 further comprising
taking the combination sheet and medusa out of the first bath; and
placing the combination sheet and medusa into a second bath.

4. The method of claim 3 further comprising
taking the combination sheet and medusa out of the second bath;
placing the combination sheet and medusa on top of a second towel; and
allowing the medusa to dry.

5. The method of claim 4 further comprising
applying color to the medusa.

6. The method of claim 5 further wherein
color is applied to the medusa by soaking the combination sheet and medusa in a third bath.

7. The method of claim 6 further comprising
allowing the medusa to dry after the combination sheet and medusa has soaked in the third bath.

8. The method of claim 1 wherein
the sheet is comprised of fiber glass filter paper.

9. The method of claim 1 wherein
the first towel is located on top of a first stack of a plurality towels.

10. The method of claim 2 wherein
the first bath is comprised of a solution of ten percent formalin.

11. The method of claim 3 wherein
the second bath is comprised of water.

12. The method of claim 4 wherein
the second towel is located on top of a second stack of a plurality of towels.

13. The method of claim 6 wherein
the third bath is comprised of a biological stain dissolved in a solvent.

14. The method of claim 2 wherein
the medusa is allowed to dry for between twelve and thirt-six hours prior to placing the combination sheet and medusa into the first bath.

15. The method of claim 3 wherein
the combination sheet and medusa is allowed to float in the first bath for about thirty minutes.

16. The method of claim 4 wherein
the combination sheet and medusa soaks in the second bath for about thirty minutes.

17. The method of claim 7 wherein
the combination sheet and medusa soaks in the third bath for from ten to thirty minutes.

18. An apparatus compising
a sheet; and
a medusa.

19. The apparatus of claim 18 wherein
the sheet is comprised of fiber glass.
